(19) United States
(12) Patent Application Publication
(10) Pub. No.: US 2009/0012810 A1
(43) Pub. Date: Jan. 8, 2009

(54) Method for using an electromagnetic scratchcard to provide services

(75) Inventors: Frank Muller, Delft (NL); Franciscus Lambertus Nicolaas Ruijs, Maren Kessel (NL)

Correspondence Address: MICHAELSON & ASSOCIATES, P.O. BOX 8489, RED BANK, NJ, 07701-8489, US

(73) Assignee: KONINKLIJKE KPN N.V., The Hague (NL)

(21) Appl. No.: 12/231,374

(22) Filed: Sep. 2, 2008

Related U.S. Application Data
(63) Continuation of application No. 10/539,084, filed on Jun. 15, 2005.

(30) Foreign Application Priority Data
Mar. 31, 2003 (EP) 1023058
Oct. 16, 2003 (EP) 1024547

(51) Int. Cl. G06Q 99/00

(52) U.S. Cl. 705/1

(57) ABSTRACT

The invention pertains to a system and a method for using an electromagnetic scratchcard to provide services between a terminal accessible to a service customer and an infrastructure. The system comprises a network and a server of a service provider, whereby an activation code is present in electronic or magnetic form on the electromagnetic scratchcard and whereby the activation code is used to activate a card balance that is associated with the electromagnetic scratchcard and is stored in the server.

### CLAIM TO PRIORITY

This application claims the benefit of our co-pending United States patent application entitled “METHOD FOR USING AN ELECTROMAGNETIC SCRATCHCARD TO PROVIDE SERVICES” filed Jun. 15, 2005 and assigned Ser. No. 10/539,084, which is incorporated by reference herein.

### FIELD OF THE INVENTION

The invention pertains to a method for using an electromagnetic scratchcard to provide services between a terminal that is accessible to the service customer and a service provider's infrastructure that is connected to the aforementioned terminal during usage.

### BACKGROUND OF THE INVENTION

A known prepaid phonecard is the so-called scratchcard. By scratching away a protective layer, the user can make visible a code present on the scratchcard. To use the balance that the scratchcard represents, the user must dial an access number of the service provider and then enter the aforementioned code. Subsequently, the user must dial the required “B” number to set up the telephone connection. The mechanism for reducing the balance on the prepaid scratchcard is located in the service provider's infrastructure. The method using the scratchcard requires the user to key in a long series of numbers in order to set up the telephone connection, which the user experiences as user-unfriendly.

Another known method is described in patent application PCT/EP01/011310 that pertains to providing services by means of a prepaid chipcard. According to that method, the identity and validity of the chipcard must be verified from within the service provider's infrastructure before it is possible to use the chipcard. A disadvantage of this known method, however, is that it does not provide a secure procedure for executing verification.

An objective of the present invention is to eliminate the aforementioned customer-unfriendliness by placing the code electronically or magnetically on the card. This creates a prepaid electronic or magnetic scratchcard, for example a prepaid chipcard with an electronic scratch code, thus greatly reducing the string of numbers the user must key in. If the code occurs on a chipcard in electronic form, however, a danger exists that the code will be copied to another chipcard, thus facilitating fraudulent use. A possibility for combating fraud is to use a simple electronic lock to protect the electronic code against copying attempts. However, a simple electronic lock provides insufficient proper protection. Knowledge of how to unlock an electronic scratchcard's lock means the same unlocking will be usable for all other electronic scratchcards. To improve protection of the electronic code, relatively expensive logics are required on the electronic scratchcard according to the state of the art.

### SUMMARY OF THE INVENTION

An objective of the present invention is to eliminate the disadvantages of the prior art and to provide a method and a system enabling an electronic or magnetic code on a prepaid card to be used to scratch open the prepaid card securely, without the need for relatively expensive logics to be present on the prepaid card.

As the invention applies both to electronic and to magnetic scratchcards, this document refers, where applicable, to an “electromagnetic scratchcard”, which refers to electronic or magnetic data storage, or both. Electronic storage can take place in, for example, a semiconductor memory of the chipcard, while magnetic storage can take place in a memory in which information can be copied and read magnetically.

For this purpose, the invention embodies a method for using an electromagnetic scratchcard to provide services between a terminal accessible to a service user and an infrastructure that comprises a network and a server of a service provider, whereby an activation code is present in electronic or magnetic form on the electromagnetic scratchcard and whereby the activation code is used to activate a card balance that is associated with the electromagnetic scratchcard and is accessible to the server.

The electromagnetic scratchcard thus created can, in one embodiment, be activated as soon as an activation code originating from the electromagnetic scratchcard is offered to a service provider's server via a terminal and a network.

It should be noted that the scratchcard is usable for services from various service providers.

To read out the activation code from the electromagnetic scratchcard, it is first necessary, in one embodiment, to offer to the electromagnetic scratchcard an activation challenge associated with the electromagnetic scratchcard. To verify whether the offered activation challenge is correct, the activation challenge is compared, by means of simple logics, with an initial challenge present on the electromagnetic scratchcard in electronic or magnetic form. If the activation challenge is correct, the activation code will be released.

According to this invention, the offered activation challenge can, in a further embodiment, be stored on the electromagnetic scratchcard. A result present in electronic or magnetic form on the electromagnetic scratchcard will be assigned the value of the activation code, by means of simple logics on the electromagnetic scratchcard, provided that the offered challenge is correct. If an incorrect activation challenge is offered to the electromagnetic scratchcard, the result will be assigned an error code. In this way, instances of attempted fraud will be recorded on the electromagnetic scratchcard. The result will be sent via the service provider's infrastructure to the server where verification will occur of whether the result has the correct value necessary to activate the electromagnetic scratchcard.

According to this invention, the status of the electromagnetic scratchcard can also be recorded on the electromagnetic scratchcard. In this way, it is possible to record whether the electromagnetic scratchcard is, for example, non-active, activated or empty.

### BRIEF DESCRIPTION OF THE FIGURES

The foregoing and the envisaged advantages of this invention will be further clarified by reading the detailed description given below in conjunction with examination of the accompanying figures, which are intended solely for illustration and not for limitation of the principle of the invention, whereby:

FIG. 1 is a block diagram that shows an electronic scratchcard (1) together with the context in which the electronic scratchcard (1) will be used.

FIG. 2 is a block diagram that shows the structure of the electronic scratchcard (1).

FIG. 3 is a flow diagram that shows the different steps that occur during reading and activation of an electronic scratchcard (1) to be able to use a service offered by a service provider.

FIG. 4 is a block diagram that shows the structure of the database (10) in more detail.

### EXPLANATORY EMBODIMENTS

It should be noted that the figure descriptions given below pertain to an electronic scratchcard, i.e., a card in which information is stored electronically. As mentioned earlier, the invention is not confined to this particular embodiment, because information is also storable magnetically. This is the reason why the claims refer to an “electromagnetic scratchcard”.

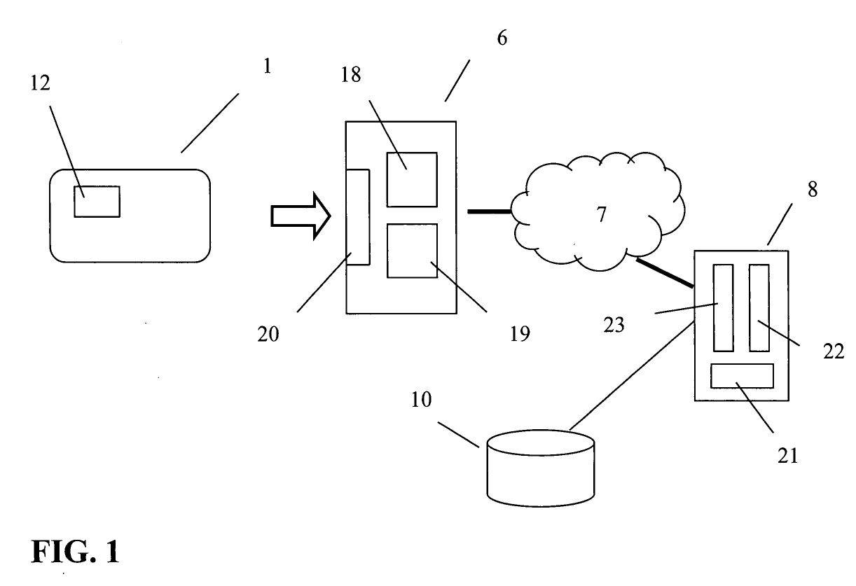

FIG. 1 shows an advantageous embodiment of the invention. The shown electronic scratchcard (1) is, for example, a prepaid chipcard. The term scratching as employed here refers to the release of an electronic code present in an electronic circuit (12) on the electronic scratchcard (1) in order to use the electronic scratchcard (1). A terminal (6) contains the facilities that allow a user to insert the facilities on the electronic scratchcard (1) and to exchange data electronically with the electronic scratchcard. The terminal (6) comprises a processor (18), an electronic storage medium (19) and an input and output device (20). The terminal (6) is connected to an infrastructure (7) of the service provider. This connection may have been created in any suitable way, for example by such means as all kinds of leased lines (copper-wire, fiber-optic, etc.) or by means of a wireless connection. The infrastructure (7) shown in the figure is a fixed or mobile infrastructure that is suitable for providing telephony-related services to users. A server (8) is connected to the infrastructure (7) and can exercise control over the way users are able to use telephony-related services. The server (8) is a computing unit with a processor (21), a memory (22) and an input and output device (23). A database (10) contains data concerning electronic scratchcards (1).

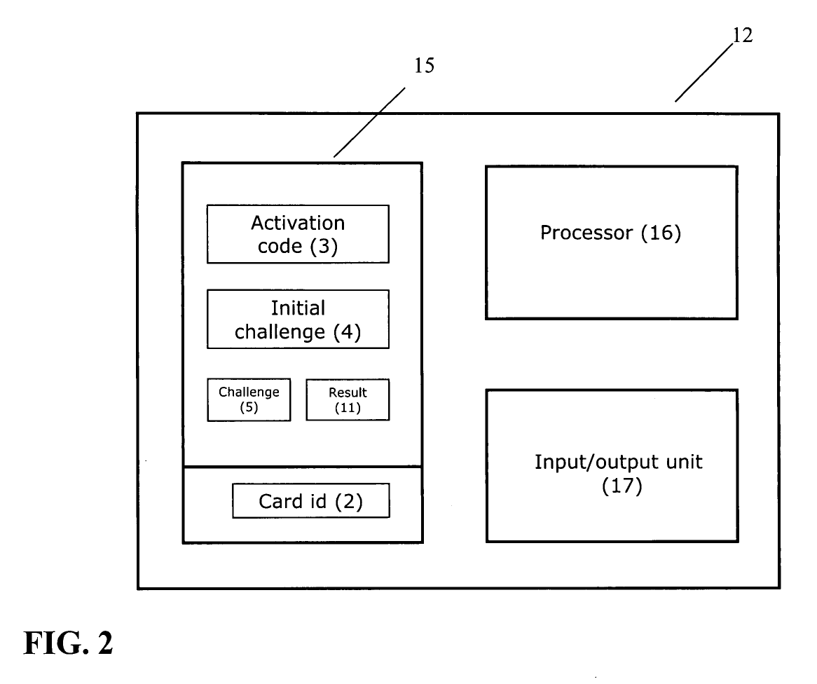

To be able to use the service, the user must insert an electronic scratchcard (1) in a terminal (6). Before the user can actually use the electronic scratchcard (1), a secure procedure is run to activate the electronic scratchcard (1). To allow the procedure to take place securely, the electronic circuit (12) on the electronic scratchcard (1) contains several components that are explained in FIG. 2.

FIG. 2 shows how the electronic circuit (12) of the electronic scratchcard (1) is structured. The electronic circuit (12) contains an electronic storage medium (15), a processor (16) and an input and output device (17). The electronic storage medium (15) on the electronic scratchcard (1) contains a card ID (2). The card ID (2) is, for example, a random value from a very large set. The electronic storage medium (15) further contains an activation code (3). The activation code (3) is the code that, through a secure procedure, must be derived from the electronic scratchcard (1) and then offered, via a network (7), to a server (8) so as subsequently to activate the electronic scratchcard (1). If the electronic scratchcard (1) has been activated, the user will be able to use the service. The activation code (3) is different for each electronic scratchcard (1) and is held in a secure way on the electronic scratchcard (1). After the electronic scratchcard (1) has been issued, the memory location with the activation code (3) can be read only. The activation code (3) is similar to the code that becomes visible on an “ordinary” scratchcard after “scratching” by the user.

To make the activation code (3) secure, the electronic scratchcard additionally contains an initial challenge (4) that, like the activation code (3) itself, is blocked to prevent read-out actions. Moreover, the electronic scratchcard (1) contains a challenge (5) and a result (11). The initial challenge (4) is a code that must be offered, via the network (7), to the electronic scratchcard (1) in order to derive the activation code (3) from the electronic scratchcard (1) and thus activate the electronic scratchcard (1). After the electronic scratchcard (1) has been issued, the memory location containing the initial challenge (4) can be read only.

The challenge (5) is a code that indicates the value that has been offered to the electronic scratchcard (1) for the purpose of activating the card, and by means of which it is further possible to read out the status of the electronic scratchcard (non-active, active, empty), whereby the initial value is C1 (non-active). After the electronic scratchcard (1) has been issued, the memory location with the challenge (5) is capable of being read and written.

In one embodiment, the challenge (5) is placed on the electronic scratchcard (1) by means of a PROM (Programmable Read Only Memory). The bits of the challenge (5) are writable only from “1” to “0” and not back. The consequence of this is that the maximum number of attempts to “guess” the challenge (5) is limited to the length of the challenge (5) in bits minus one. After a fraudulent person has fruitlessly exhausted the number of attempts, there will be an incorrect challenge (5) on the electronic scratchcard (1), i.e., a challenge (5) that is not equal to the initial challenge (4). An advantage of this invention is that, in this way, it can be seen from the challenge (5) whether an attempt of fraudulent usage has occurred. In another embodiment, the challenge (5) is a large number of, say, 64 bits that is writable without limitation. Because of the large length of the challenge (5), it is virtually impossible to “guess” the correct challenge (5), a circumstance affording protection against fraud.

In one embodiment, a result (11) is present on the electronic scratchcard (1). The result (11) is assigned a value that is determined by whether or not the correct activation challenge (9) is offered to the electronic scratchcard (1).

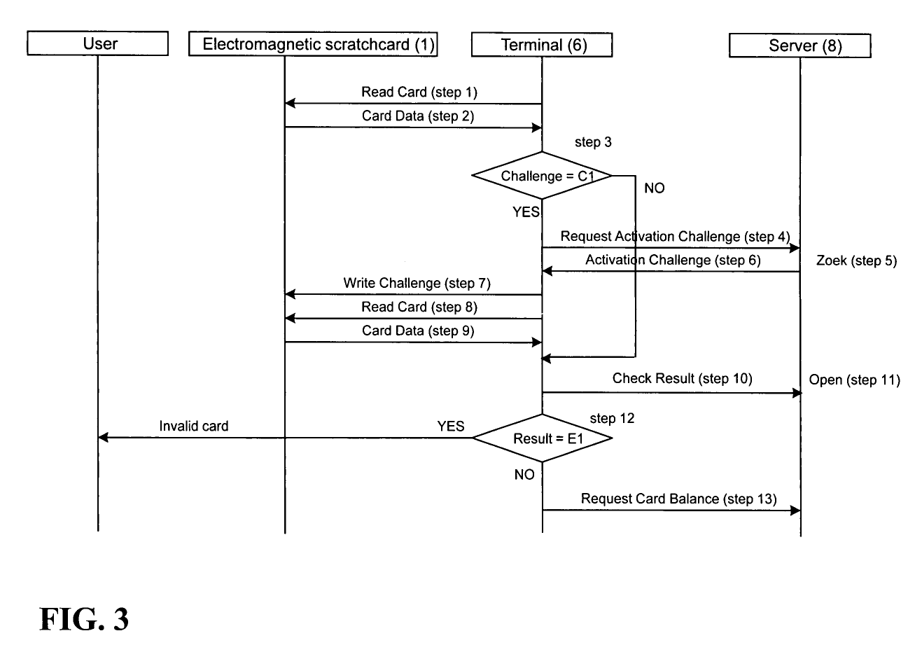

Using an embodiment of the invention, the activation procedure will be carried out (see FIG. 3). After the user has inserted the electronic scratchcard (1) in the terminal (6), a read-out instruction is sent from the terminal (6) to the electronic scratchcard (1) (step 1). The electronic scratchcard (1) responds by sending the card ID (2) and the challenge (5) to the terminal (step 2). The terminal compares the received challenge (5) with a predetermined unique code C (for example “111 . . . 1”) (step 3). If the challenge (5) is equal to C1, it means that the electronic scratchcard (1) has not yet been activated and the activation procedure must be continued further.

If the challenge (5) is equal to C1, the terminal (6) will request (step 4) the server (8) to send an activation challenge (9) to the terminal (6). Together with this request, the terminal (6) will send the card ID (2). The activation challenge (9) is a code that, provided it is identical to the initial challenge (4) on the electronic scratchcard (1), enables the activation code (3) to be derived from the electronic scratchcard (1). The activation challenge (9) is recorded centrally in a database (10) of the server (8) and is linked to the card ID (2).

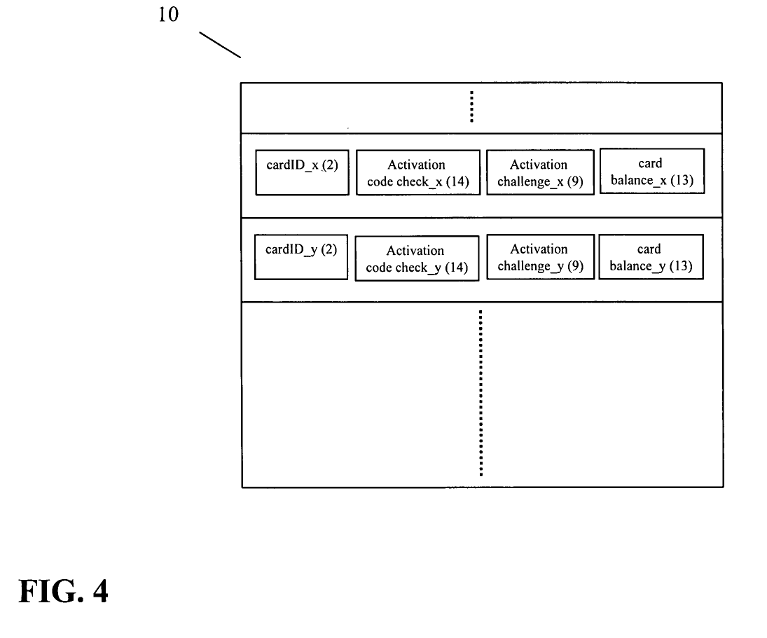

FIG. 4 shows the database (10). The database (10) is a storage medium with electronically stored data that are accessible to the server (8). For each card ID (2), the database (10) contains memory locations within which there is an activation code check (14), the activation challenge (9) and a card balance (13). The memory location associated with the card ID (2) with the activation code check (14) is used to verify whether the correct activation code (3) originating from the scratchcard (1) is being offered to the database (10). The database (10) memory location containing the activation challenge (9) associated with an electronic scratchcard (1) is readable for the purpose of offering the activation challenge (9) to the electronic scratchcard (1) in response to a request originating from the terminal (6). In another embodiment, the activation challenge (9) may also originate from a source other than the database (10), for example from the terminal (6). The activation code check (14) and the activation challenge (9) can be unique, or can be unique in combination with the card ID (2).

The database (10) memory location that contains the card balance (13) associated with a card ID (2) is a value that indicates how long, and additionally or optionally to what extent, a user may use services by means of the electronic scratchcard (1). In one embodiment, the card balance (13) is a value that is reducible by the server (8). Reduction occurs at such time or for as long as use is made of the service. When reduction has caused the card balance (13) to reach a predefined value (for example, “0”), it will cease to be possible to use the services by means of the electronic scratchcard (1) in question.

According to this invention, the server (8) finds the activation challenge (9) associated with the received card ID (2) (step 5), and the activation challenge (9) is sent to the terminal (6) (step 6). The terminal (6) sends the activation challenge (9) to the electronic scratchcard (1), where the challenge (5) is overwritten by the activation challenge (9) (step 7). The terminal (6) then sends to the electronic scratchcard (1) a request to receive a result (11) (step 8). On the electronic scratchcard (1), the challenge (5), which in the meantime contains a value equal to the activation challenge (9) received earlier from the server (8), is compared with the initial challenge (4). If the challenge (5) is equal to the initial challenge (4), the value of the activation code (3) will be assigned to the result (11). If the challenge (5) is unequal to the initial challenge (4), the result (11) will be given a value of, for example, E1, which represents an error code (for example “00 . . . 0”). The result (11) will then be sent to the terminal (6) (step 9).

Subsequently, the card ID (2) and result (11) will be sent (step 10) from the terminal (6) to the server (8). The server checks whether the result (11) corresponds with the value of the activation code (3) in the database (10) that is associated with the card ID (2). If this is the case, the balance associated with the card ID (2) will be activated (step 11). If the result is unequal to the value of the activation code (3) in the database (10), the balance associated with the card ID (2) will not be activated.

Before the balance associated with the electronic scratchcard (1) is retrieved, the terminal (6) will check whether the result (11) is equal to E1 (step 12). If this is not the case, the terminal (6) can retrieve the activated balance (step 13) and the user of the electronic scratchcard (1) will be able to use the desired service. If the result (11) is equal to E1, however, the terminal (6) will inform the user that the electronic scratchcard (1) is invalid.

As such time as the electronic scratchcard (1) becomes exhausted, the server (8) will recognize this circumstance from the value of the card balance (13) (for example, because it has the value “0”), and the server (8) will indicate that the balance associated with the electronic scratchcard (1) has been exhausted. The terminal (6) will then give the challenge (5) a value of C2 (for example, “00 . . . 0”). This value C2 indicates that the card balance (13) associated with the electronic scratchcard has been exhausted. If the electronic scratchcard (1) is active and not empty, the challenge (5) will have a value that is not equal to C1 or C2, but a value that corresponds with the offered activation challenge (9) (or, in the case of fraudulent use or an error, a different value). An advantage of the invention is that, in this way, it can be seen from the challenge (5) whether the electronic scratchcard (1) is non-active, active or empty. If the challenge (5) is not equal either to C1 or to C2, it is moreover possible to detect from the result (11) whether there has been an attempt of fraudulent usage. In such a case, the result (11) will be equal to E1, which is caused by a difference between the initial challenge (4) and the challenge (5). This indicates that an attempt has been made to obtain the activation code (3) from the electronic scratchcard (1) using an incorrect activation challenge (9).

We claim:

1. A server that is connected to an infrastructure not directly accessible to a service customer, such infrastructure comprising a network of a service provider, and connected to a database, such server being arranged to:
receive from a terminal electronic or magnetic data via the network;
compare the electronic or magnetic data received from the terminal with the electronic or magnetic data contained in the database;
retrieve electronic or magnetic data from the database on the basis of electronic or magnetic data received from the terminal and send such data via the network to the terminal;
modify electronic or magnetic data in the database based on electronic or magnetic data received from the terminal;
retrieve from the database an activation challenge associated with a card ID and send it via the network to the terminal, such card ID received via the terminal uniquely defining an electromagnetic scratchcard.

2. A server according to claim 1, whereby the server is arranged to reduce de card balance in the database depending upon a service provided to the user of the electromagnetic scratchcard.
